(19) United States
(12) Patent Application Publication
(10) Pub. No.: US 2013/0090997 A1
(43) Pub. Date: Apr. 11, 2013

(54) CONDITIONAL PURCHASING AND VENDING SYSTEMS

(71) Applicant: Dahai Ren, Waltham, MA (US)

(72) Inventor: Dahai Ren, Waltham, MA (US)

(73) Assignee: VERIZON PATENT AND LICENSING INC., Basking Ridge, NJ (US)

(21) Appl. No.: 13/253,251

(22) Filed: Oct. 5, 2011

(51) Int. Cl. G06Q 30/02

(52) U.S. Cl. 705/14.23; 705/26.1

(57) ABSTRACT

A device may receive a request from a purchaser device indicating that a participant will purchase a product associated with a first conditional sales offer, at a first discount price, on a condition that a total number of participants requesting to purchase the product at the first discount price reaches a first threshold number. The device may also determine whether the first conditional sales offer is still open; determine whether the condition that the total number of participants requesting to purchase the product at the first discount price reaches the first threshold number has been satisfied when the first conditional sales offer is determined to be closed; and complete a sale of the product to the participant at the first discount price when the condition is satisfied.

### BACKGROUND INFORMATION

Many of today's commercial transactions are conducted via client and server applications. A client application for commercial transactions may reside on a personal computer, a laptop computer, or a handheld communication device. In some instances, a client application may take the form of a web page, a plug-in, or a stand-alone application. In contrast, server applications may typically reside on server devices capable of handling heavy network traffic.

### BRIEF DESCRIPTION OF THE DRAWINGS

FIG. 1 illustrates concepts described herein;

FIGS. 2A and 2B are front and rear views of the exemplary purchaser device of FIG. 1;

FIG. 3 is a block diagram of exemplary components of devices of FIG. 1;

FIG. 4 is a block diagram of exemplary functional components of the server device of FIG. 1;

FIG. 5A illustrates exemplary profits as functions of a number of buyers, for different prices;

FIG. 5B illustrates exemplary profits as functions of a number of sellers, for different prices;

FIG. 6 illustrates an exemplary graphical user interface (GUI) that is associated with a purchaser device of FIG. 1;

FIG. 7 illustrates an exemplary GUI that is associated with a vendor device of FIG. 1;

FIG. 8 is a flow diagram of an exemplary process that is associated with conditional sales; and

FIG. 9 is a flow diagram of an exemplary process that is associated with conditional purchases.

### DETAILED DESCRIPTION OF PREFERRED EMBODIMENTS

The following detailed description refers to the accompanying drawings. The same reference numbers in different drawings may identify the same or similar elements. In the following, depending on the context, the terms “purchasing,” “buying,” “sale,” “selling,” “vending,” “licensing,” and similar terms may be used synonymously. In addition, depending on the context, the terms may not only refer to ordinary meanings ascribed to the terms, but may also refer to meanings associated with other types of commercial transactions, such as service agreements, leasing, certain types of contracts, etc. In addition, depending on the context, the term “product” may include a service, license, etc.

As described below, a system may allow a buyer to purchase a product at a specified discount price from the system under the condition that a given number of buyers also agree to purchase the same product within a prescribed time. If not enough buyers participate in the conditional purchases, the system does not sell the items to the participating buyers at the discount price.

Similarly, the system may allow a vendor to sell a product at a premium price to the system, under the condition that a given number of vendors also agree to sell predetermined product(s) in a prescribed time. If not enough vendors participate in the conditional sales, the system does not buy the product(s) from the participating vendors at the premium price.

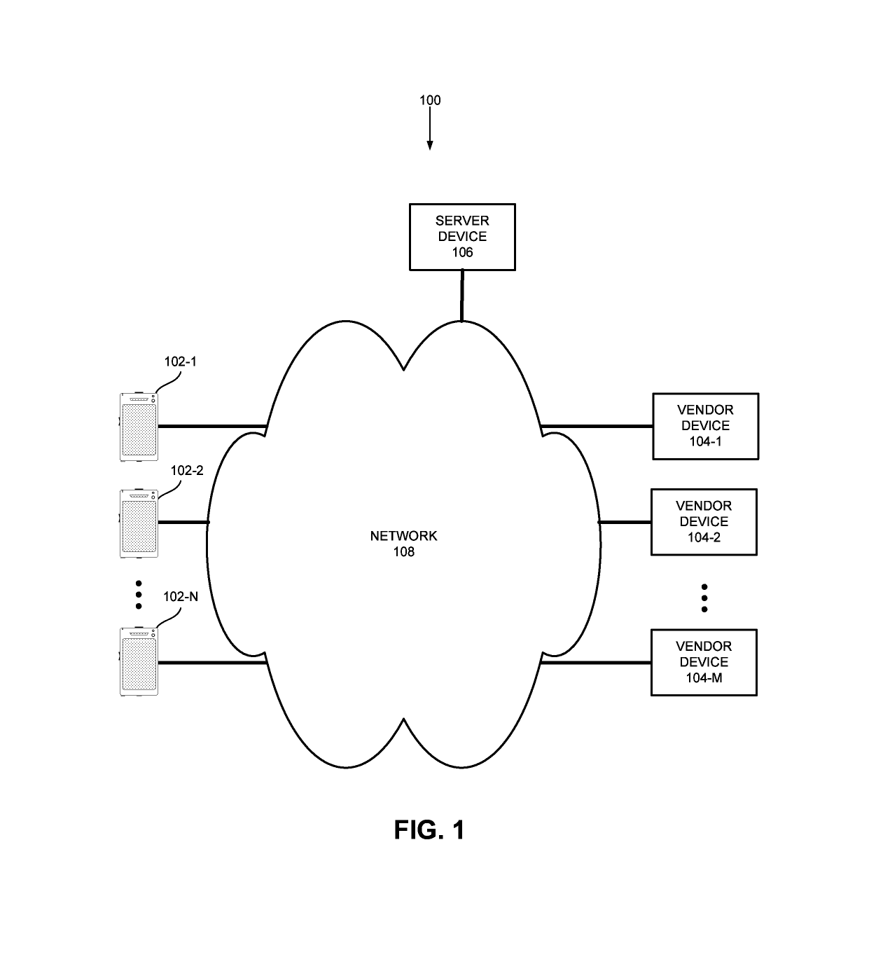

FIG. 1 illustrates the concepts described herein. FIG. 1 shows an exemplary network 100 that includes purchaser devices 102-1 through 102-N, where N is an integer greater than zero (individually “purchaser device 102” and collectively “purchaser devices 102”), vendor devices 104-1 through 104-M, where M is an integer greater than zero (individually “vendor device 104” and collectively “vendor devices 104”), server device 106, and network 108.

Purchaser device 102 may provide a graphical user interface (GUI) for conditionally purchasing a product from server device 106. In purchasing a product, service, a piece of software, etc., purchaser device 102 may conduct a transaction with server device 106, exchange messages with server device 106, etc.

Vendor device 104 may provide a GUI for conditionally selling a product to server device 106. In selling a product, service, apiece of software, etc., vendor device 104 may conduct a transaction with server device 106.

Server device 106 may communicate with purchaser devices 102 and vendor devices 104 over network 108 in conditionally selling or buying a product (e.g., an item, service, license, etc.). In some implementations, server device 106 may further impose conditions on buying a set of products from sellers on other transactions, such as sales of the products to buyers at purchaser devices 102.

Network 108 may include a wired or wireless network over which devices communicate (e.g., a fiber-optic network, a local area network (LAN), a wide area network (WAN), a wireless LAN, a metropolitan area network (MAN), a cellular network, a public switched telephone network (PSTN), an intranet, the Internet, a satellite-based network, any other network, or a combination of networks).

In FIG. 1, when server device 106 validates a pending transaction, that is when server device 106 determines that conditions for the transaction have been met or satisfied, server device 106 may complete the transaction by billing the purchaser, paying the vendor, shipping the product, etc. In one implementation, server device 106 may belong to an entity (e.g., service provider) that renders a service (e.g., an Internet service, entertainment service (e.g., video-on-demand, cable television, etc.), etc.) to the purchaser. In such a case, server device 106 may charge the purchaser's account associated with the entity. This may safeguard the purchaser from having to send a credit card number or another type of personal information over networks, a turnoff for many potential purchasers concerned about network security.

Network 100 is exemplary and is illustrated for simplicity. In an actual implementation, network 100 may include additional devices (e.g., additional server devices 106), fewer devices (e.g., fewer vendor devices 104), different devices (e.g., bridges, routers, gateways, etc.), and/or different arrangement of devices than those illustrated in FIG. 1. In addition, two more devices may replace a single device. Conversely, one device may implement the functionalities of two or more devices (e.g., one device may be used as purchaser device 102 and vendor device 104).

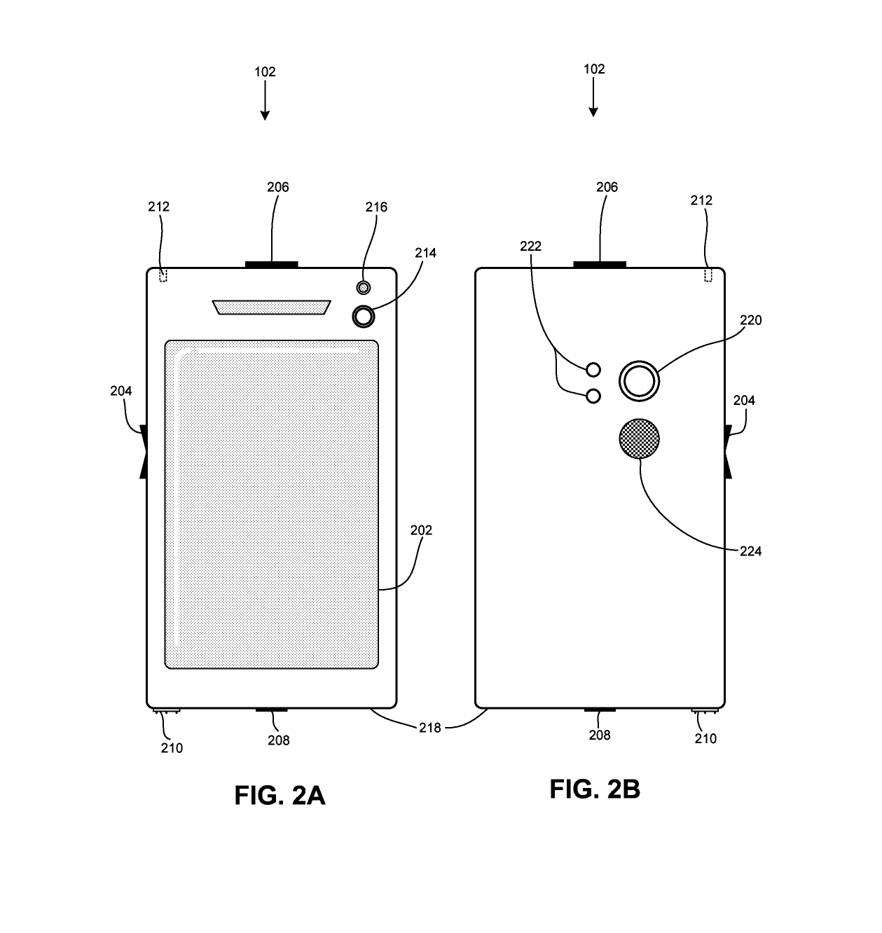

FIGS. 2A and 2B are front and rear views of purchaser device 102 according to one implementation. Depending on the implementation, purchaser device 102 may include any of the following devices that have the ability to or are adapted to browse web pages, display images, receive input, and/or conduct a commercial transaction over network 108: a cellular telephone (e.g., smart phone); a tablet computer; an electronic notepad; a gaming console; a laptop, and/or a personal computer; a multimedia capturing/playing device; a web-access device; a music playing device; a digital camera; or another type of device.

As shown in FIGS. 2A and 2B, purchaser device 100 may include a display 202, volume rocker 204, awake/sleep button 206, microphone 208, power port 210, speaker jack 212, front camera 214, sensors 216, housing 218, rear camera 220, light emitting diodes 222, and speaker 224. Depending on the implementation, purchaser device 102 may include additional, fewer, different, or different arrangement of components than those illustrated in FIGS. 2A and 2B.

Display 202 may provide visual information to the user. Examples of display 202 may include a liquid crystal display (LCD), a plasma display panel (PDP), a field emission display (FED), a thin film transistor (TFT) display, etc. In some implementations, display 202 may also include a touch screen that can sense contacting a human body part (e.g., finger) or an object (e.g., stylus) via capacitive sensing, surface acoustic wave sensing, resistive sensing, optical sensing, pressure sensing, infrared sensing, and/or another type of sensing technology. The touch screen may be a single-touch or multi-touch screen.

Volume rocker 204 may permit a user to increase or decrease speaker volume. Awake/sleep button 206 may put purchaser device 102 into or out of the power-savings mode. Microphone 208 may receive audible information and/or sounds from the user and from the surroundings. Power port 210 may allow power to be received by purchaser device 102, either from an adapter (e.g., an alternating current (AC) to direct current (DC) converter) or from another device (e.g., computer).

Speaker jack 212 may include a plug into which one may attach speaker wires (e.g., headphone wires), so that electric signals from purchaser device 102 can drive the speakers, to which the speaker wires run from speaker jack 212. Front camera 214 may enable the user to view, capture, store, and process images of a subject in/at front of purchaser device 102. In some implementations, front camera 214 may be coupled to an auto-focusing component or logic and may also operate as a sensor.

Sensors 216 may collect and provide, to purchaser device 102, information pertaining to purchaser device 102 (e.g., movement, orientation, etc.) and/or information that is used to aid a user in capturing images (e.g., for providing information for auto-focusing). Some sensors may be affixed to the exterior of housing 218, as shown in FIG. 2A, and other sensors may be inside housing 218.

Housing 218 may provide a casing for components of purchaser device 102 and may protect the components from outside elements. Rear camera 220 may enable the user to view, capture, store, and process images of a subject in/at back of purchaser device 102. Light emitting diodes 222 may operate as flash lamps for rear camera 220. Speaker 224 may provide audible information from purchaser device 102 to a user/viewer of purchaser device 102.

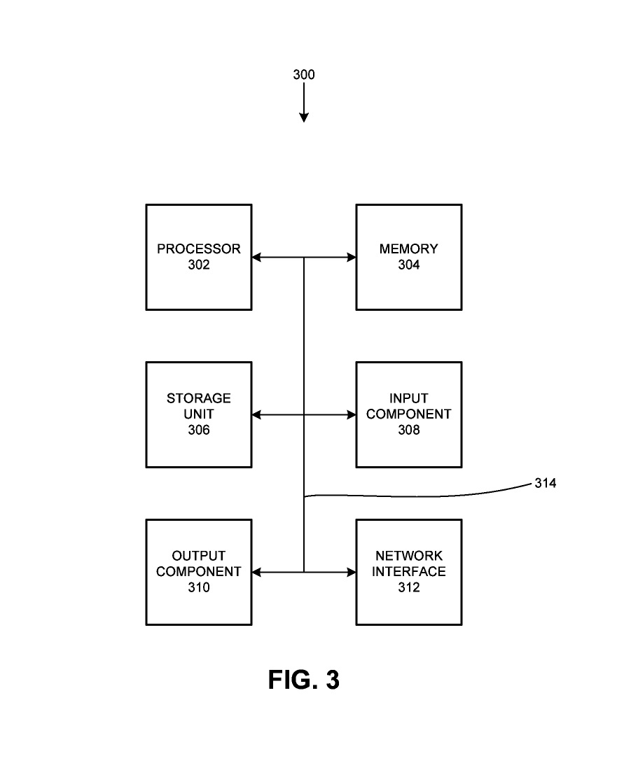

FIG. 3 is a block diagram of exemplary components of a network device 300. Depending on the implementation, network device 300 may correspond to any of purchaser devices 102, vendor devices 104, and/or server device 106. As shown, device 300 may include a processor 302, memory 304, storage unit 306, input component 308, output component 310, network interface 312, and communication path 314. In different implementations, network device 300 may include additional, fewer, different, or different arrangement of components than the ones illustrated in FIG. 3. For example, network device 300 may include line cards for connecting to external buses.

Processor 302 may include a processor, a microprocessor, an Application Specific Integrated Circuit (ASIC), a Field Programmable Gate Array (FPGA), and/or other processing logic (e.g., embedded devices) capable of controlling network device 300. Memory 304 may include static memory, such as read only memory (ROM), and/or dynamic memory, such as random access memory (RAM), or onboard cache, for storing data and machine-readable instructions (e.g., programs, scripts, etc.). Storage unit 306 may include a floppy disk, CD ROM, CD read/write (R/W) disc, and/or flash memory, as well as other types of storage devices (e.g., hard disk drive) for storing data and/or machine-readable instructions (e.g., a program, script, etc.). As used herein, the term “computer-readable medium” may include memory 304 or storage unit 306.

Input component 308 and output component 310 may provide input and output from/to a user to/from network device 300. Input/output components 308 and 310 may include a display screen, a keyboard, a mouse, a speaker, a microphone, a camera, a DVD reader, Universal Serial Bus (USB) lines, and/or other types of components for converting physical events or phenomena to and/or from signals that pertain to network device 300.

Network interface 312 may include a transceiver (e.g., a transmitter and a receiver) for network device 300 to communicate with other devices and/or systems. For example, via network interface 312, network device 300 may communicate over a network, such as the Internet, an intranet, a terrestrial wireless network (e.g., a WLAN, WiFi, WiMax, etc.), a satellite-based network, optical network, etc. Network interface 312 may include a modem, an Ethernet interface to a LAN, and/or an interface/connection for connecting network device 300 to other devices (e.g., a Bluetooth interface).

Communication path 314 may provide an interface through which components of network device 300 can communicate with one another.

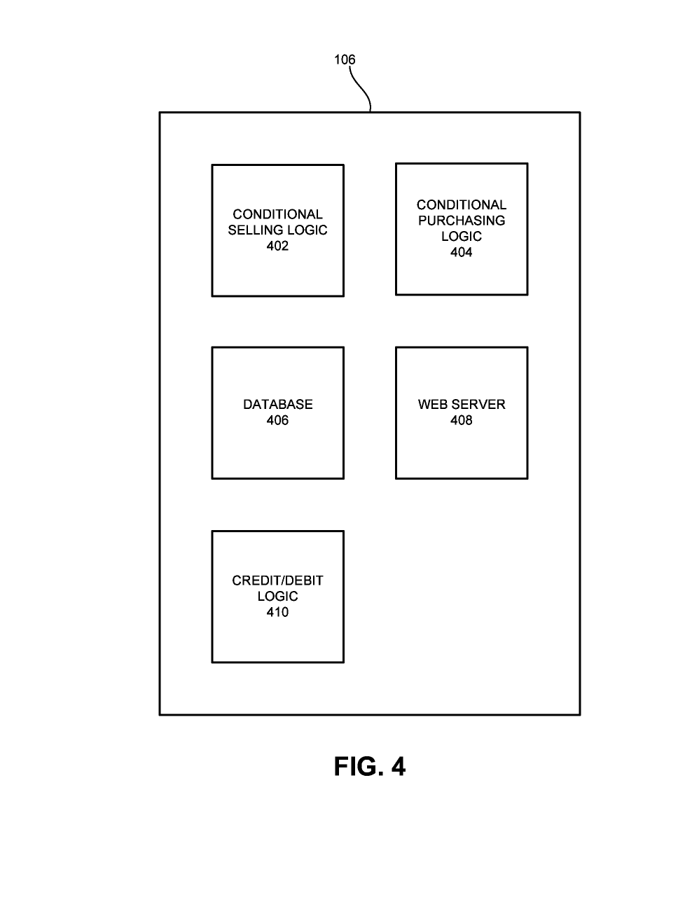

FIG. 4 is a block diagram of exemplary functional components of server device 106. As shown, server device 106 may include conditional selling logic 402, conditional purchasing logic 404, database 406, web server 408, and payment/receipt logic 410. Depending on the implementation, components may be implemented as software (e.g., processor executable instructions, scripts, etc/on a computer readable medium) or as a combination of software and hardware.

Conditional selling logic 402 may receive requests from purchaser devices 102 (e.g., via web server 408) to participate in conditional purchases/sales. In conducting the conditional sales, conditional selling logic 402 may track identities of participants that contact server device 106. If conditions associated with the sales are satisfied, conditional selling logic 402 may sell products, services, etc. to the participating buyers.

In some implementations, in interacting with purchaser devices 102, conditional selling logic 402 may set or specify a sales condition that specifies a minimum number of purchasers for a set of sales to be completed. In other implementations, in interacting with purchaser devices 102, conditional selling logic 402 may set a sales condition that specifies a series of numbers of purchasers (N1, N2, N3, . . . ) and prices corresponding to the numbers (P1, P2, P3, . . . ), such that N1<N2<N3 . . . and P1>P2>P3 . . . . Assume that P is the current price of the product(s) and N is the current number of participants. If the number of participants N falls between N1 and N2 (N1<N<N2), then conditional selling logic 402 will sell the product(s) to the N participants at P1. N2<N<N3, then conditional selling logic 402 will sell the product(s) to the N participants at P2. Generally, if NX<N<NX+1, then conditional selling logic 402 will sell the product(s) to the N participants at PX, where X is an integer.

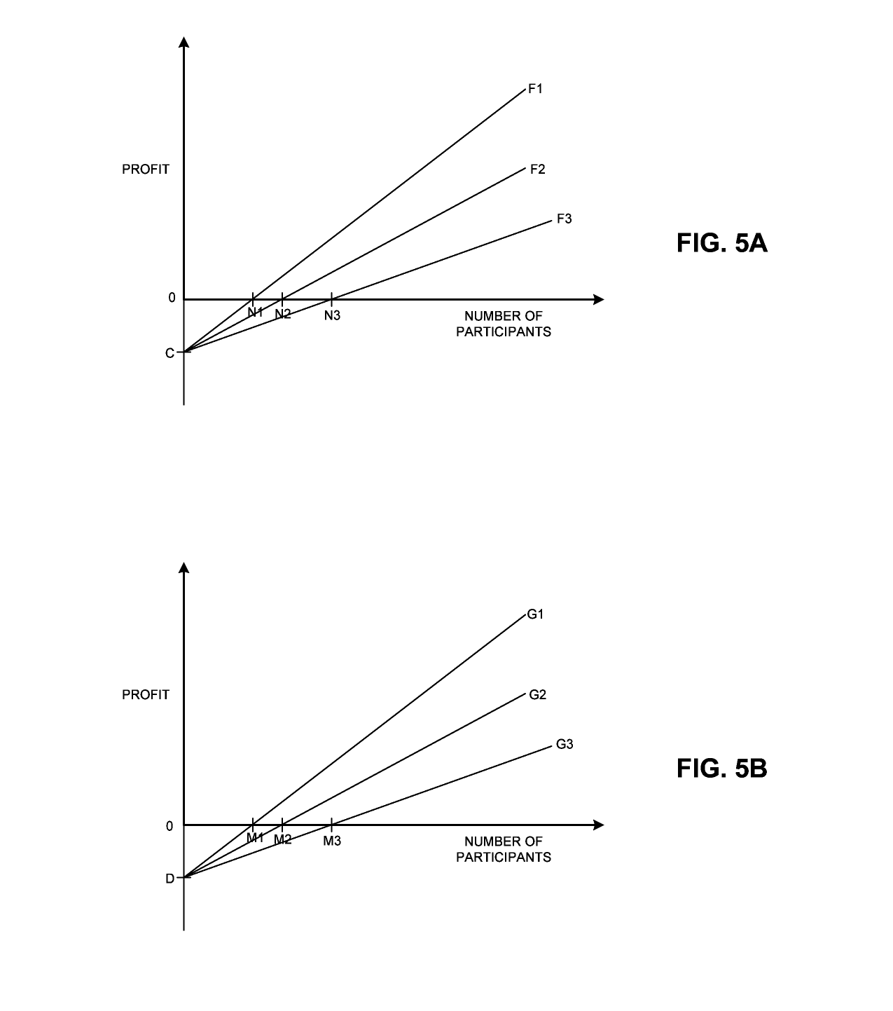

FIG. 5A illustrates exemplary profits as functions of numbers of buyers, for different prices PX at which product(s) are conditionally said to the buyers. As shown, each of F1, F2, and F3 is a function of the number of participants (i.e., purchasers) v. profit, at prices P1, P2, and P3, respectively. Each of F1, F2, and F3 has a fixed cost C (a negative profit), which may be incurred by an entity associated with server device 106. Although the fixed cost is shown as C for F1, F2, and F3, in an actual implementation, the fixed cost for the entity to sell the product(s) at different prices may be different.

As further shown, F1 yields zero profit when N=N1. When N>N1, F1 yields a positive profit. If N increases to N2, then conditional selling logic 402 may lower the price of the product being sold to P2, for example, for promotional purposes, without incurring a loss. This is illustrated by F2. If N increases to N3, conditional selling logic 402 may lower the price of the product even further to P3, without incurring a loss. Depending on the extent to which conditional selling logic 402 is, for example, promoting the supplier of the product(s), or other products from the supplier, conditional selling logic 402 may continue to lower the price as the number of participants increase. Conditional selling logic 402 may stop lowering the price at a predetermined price floor.

Returning to FIG. 4, conditional purchasing logic 404 may receive requests (e.g., via web server 408) from vendor devices 104 to participate in conditional sales/purchases. In conducting the conditional purchases, conditional purchasing logic 404 may track identities of potential sellers (or simply “sellers”) that contact server device 106. If the conditions associated with the purchases are satisfied, conditional purchasing logic 404 may purchase products, services, licenses, etc., from participating vendors/sellers.

In some implementations, in interacting with vendor devices 104, conditional purchasing logic 404 may set or specify a purchasing condition that specifies a minimum number of sellers for a set of purchases to be completed. In other implementations, conditional purchasing logic 404 may set a purchasing condition that specifies a series of numbers of sellers (M1, M2, M3, . . . ) and prices corresponding to the numbers (R1, R2, R3, . . . ), such that M1<M2<M3 . . . , and R1<R2<R3 . . . . Assume that R is the current price of products and M is the current number of participants. If the number of participants M falls between M1 and M2 (M1<M<M2), then conditional purchasing logic 404 will buy the products from the M sellers at R1. If M2<M<M3, then conditional purchasing logic 404 will buy the products from the M participants at R2. Generally, if MY<M<MY+1, then conditional purchasing logic 404 will buy the product(s) from the M participants at RY, where Y is an integer.

FIG. 5B illustrates exemplary profits as functions of number of sellers, for different prices RY at which products are conditionally purchased from the sellers. In the FIG. 5B, “profit” is the profit to be made by an entity associated with server device 106 (e.g., entity purchasing the products from the seller) when the entity eventually resells the products. As shown, each of G1, G2, and G3 is a function of the number of participants (i.e., sellers/vendors) v. profit, at prices R1, R2, and R3, respectively. Each of G1, G2, and G3 has a fixed cost D (a negative profit), which may be incurred by an entity associated with server device 106. Although the fixed cost is shown as D for G1, G2, and G3, in an actual implementation, the fixed cost for the entity to buy the product(s) at different prices may be different.

As further shown, G1 yields zero profit when M=M1. When M>M1, G1 yields a positive profit. If M increases to M2, then conditional purchasing logic 404 may increase the price of the products being purchased to R2 (for promotional purposes). This may increase the cost for the entity associated with server device 106 (e.g., a reseller). However, the increased revenue may allow the entity to avoid incurring a loss. This is illustrated by 62. If M increases to M3, conditional purchasing logic 404 may increase the price of the product(s) even further to R3, without incurring a loss. Depending on the extent to which conditional purchasing logic 404 is, for example, promoting the entity, buyers of the products, etc., conditional purchasing logic 404 may continue to increase the price as the number of participants/sellers increase. Conditional purchasing logic 404 may stop increasing the price at a predetermined price ceiling.

Returning to FIG. 4, database 406 may include buyer/purchaser information associated with, for example, identities of pending transactions, the current states of the pending transactions (e.g., the current price, the number of participants, etc.), descriptions of the pending transactions, participants' account information for accounts that exist, a history of past transactions (e.g., price, product purchased or sold, the time of the purchase/sale, etc.), participant addresses, ages, genders, methods of billing/payment for each participant (e.g., whether to charge an account, via a credit card, directly crediting a bank account, airmailing a check or an invoice, etc.).

Web server 408 may interact with a browser/client application residing on purchaser/vendor device 102/104 during a conditional sale/purchase. Web server 408 may relay information/messages between purchaser/vendor devices 102/104 and other components (e.g., conditional selling logic 402, conditional purchasing logic 404, etc.) in server device 106.

Payment/receipt logic 410 may credit or debit a participant account to complete a transaction when conditions associated with the transaction are met. For example, assume that a conditional purchase requires exactly 100 participants and that each participant is to receive a 30% discount. When each of the first 100 participants agrees to a purchase at the discount price, conditional selling logic 402 may complete the transaction by billing the participants. For example, payment/receipt logic 410 may perform a lookup in database 406 to determine the billing/debit method for each participant, and debit/bill each participant accordingly (e.g., charge an account associated with rendering a service, email an invoice, etc.).

Components in FIG. 4 are exemplary and illustrated for simplicity. Although not shown in FIG. 4, server device 106 may include other components, such as an operating system (e.g., Linux, MacOS, Windows, etc.), applications (e.g., email server application, browser, music application, video server application, picture application, instant messaging server application, phone application, etc.), etc. Furthermore, each component described above may include other functionalities. For example, conditional selling logic 402 or conditional purchasing logic 404 may be capable of selling or purchasing products or services to/from buyers/sellers without conditions that are associated with numbers of purchases or sales.

Depending on the implementation, server device 106 may include additional, fewer, different, or a different arrangement of components than those illustrated in FIG. 4. For example, in one implementation, a component may be combined with other components. In another implementation, a component may be separated into two or more components.

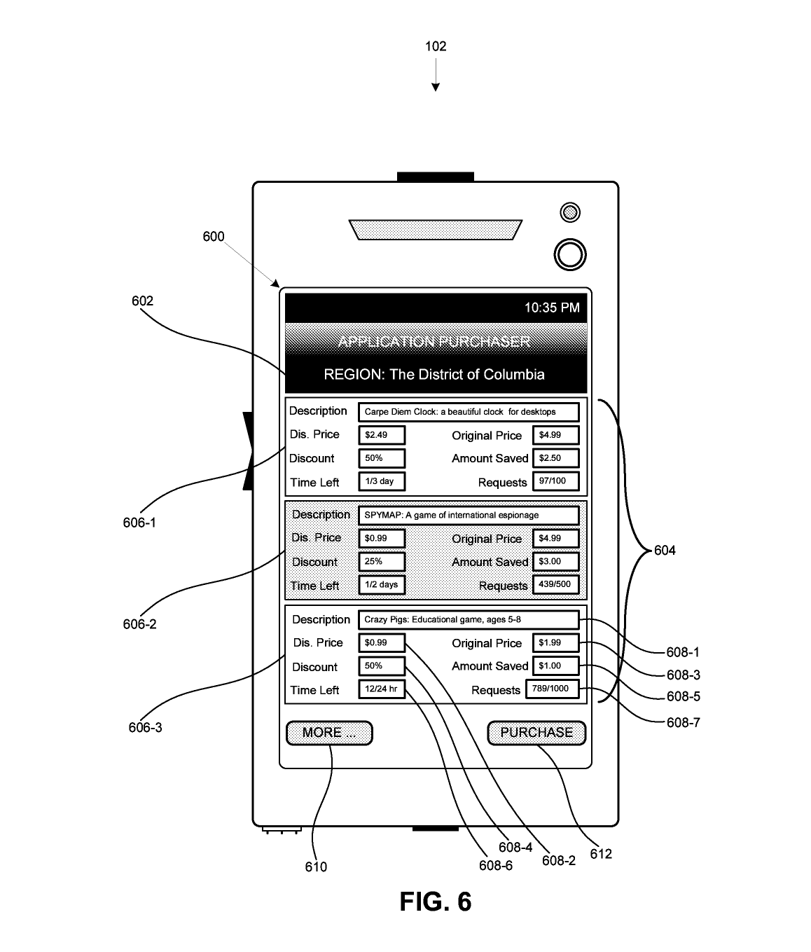

FIG. 6 illustrates an exemplary GUI 600 that is associated with purchaser device 102. Purchaser device 102, in coordination with server device 106, may provide GUI 600 to a purchaser associated with purchaser device 102 when the purchaser requests a list of conditional sell offers. In some implementations, purchaser device 102/server device 106 may provide GUI 600 in response to a query-based on a product type, price, the date when the purchase condition became available, etc. When the purchaser requests the search, purchaser device 102 may relay a search query to server device 106. In response, server device 106 may provide the information, for displaying GUI 600 to purchaser device 102.

As shown, GUI 600 may include region bar 602, listing 604, a more button 610, and a purchase button 612. Depending on the implementation, GUI 600 may include additional, fewer, different, or a different arrangement of components than those illustrated in FIG. 6 or described herein.

Region bar 602 may include information pertaining to a geographical area that is associated with the sell/sale offers in listing 604. For example, region bar 602 shows “the District of Columbia.” Accordingly, listing 604 would include offers that have been made by vendors from within the District of Columbia. In some implementations/configurations, region bar 602 may not convey geographical information (e.g., show a blank).

Listing 604 may include a list of conditional sell offers, such as conditional sell offers 606-1, 606-2, and 606-3 (individually “conditional sell offer 606” and collectively “conditional sell offers 606”). Conditional sell off 606 may include a product description field 608-1, discount price field 608-2, original price field 608-3, discount percentage field 608-4, amount saved field 608-5, time left field 608-6, and number of purchase requests field 608-7. Depending on the implementation, conditional sell offer 606 may include additional, fewer, different, or different arrangement of fields than those illustrated in FIG. 6.

Description field 608-1 may include a description of a product or products being offered for sale. Discount price field 608-2 may include the price at which the buyer will purchase a product associated with conditional sell offer 606 if the number of purchase requests or participants reach a target number provided in number of purchase requests field 608-7.

Original price field 608-3 may include a normal price of the product when the product is sold without the condition of having a minimum number of purchase requests or participants. Discount percentage field 608-4 may include the discount price divided by the original price, expressed as a percentage. For example, assume that discount price field 608-2 includes $0.99 and original price field 608-3 includes $3.99. Discount percentage field 608-4 would include $0.99/$3.99=0.25=25%. In some implementations, discount percentage field 608-4 may indicate a discounted amount as a percentage. Continuing with the prior example, discount percentage field 608-4 would include (1−0.25)=0.75=75%.

Amount saved field 608-5 may include a difference between the original price the discount price field. Time left field 608-6 may include the amount of time for which conditional sell offer 606 has been open (e.g., server device 106 is accepting participant requests to purchase the product at the discount price) and the total amount of time for which conditional sell offer 606 is to remain open. For example, in FIG. 6, time left field 608-6 shows 12/24 hours, which indicates that conditional sell offer 606 has been open for 12 hours, and is to remain open for the total of 24 hours.

Number of purchase requests field 608-7 may include a number of participants that indicated that they will purchase the product and a number of required participants for the participants to purchase the product at the discount price. For example, assume that number of participants field 608-7 includes “789/1000” and time left field 508-6 includes 12/24 hrs. In accordance with the information, conditional selling logic 402 may maintain conditional sell offer 606 for 12 more hours. If 211 (e.g., 1000−789) additional participants indicate, within the 12 remaining hours, that they will purchase the product, conditional logic 402 will sell the product to all of the 1000 participants at the discount price specified in discount price field 608-2.

More button 610, when activated by a participant, may show detailed information associated with conditional sell offer 606. The detailed information may include, for example, address of a vendor associated with the offer, detailed description of the product, a rating associated with the product, a URL to the vendor's site, etc.

Purchase button 612, when activated by a participant, may allow the participant to indicate, to server device 106, that the participant will buy the product when the target number of participants indicated in number of participants field 608-7 is reached. When the participant activates purchase button 612, purchaser device 102 may send a conditional purchase request to server device 106.

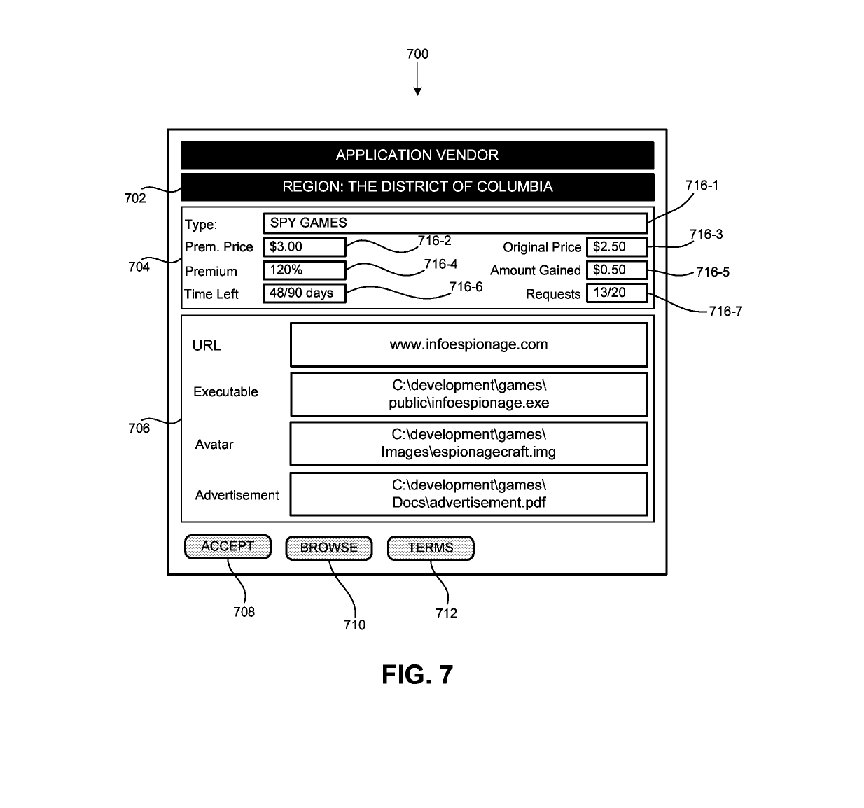

FIG. 7 illustrates an exemplary GUI 700 that is associated vendor device 104. In this implementation, vendor device 104, in coordination with server device 106, may provide GUI 700 to a vendor when the vendor requests vendor device 104 to list conditional purchase offers that are associated with software applications. In some implementations, vendor device 104/server device 106 may provide GUI 700 in response to a query based on a product type, price, the date when the purchase offer became available, etc. When the vendor requests the search, vendor device 104 may send a search query to server device 106. In response, server device 106 provide information for displaying GUI 700 to vendor device 104.

As shown, GUI 700 may include a region bar 702, conditional purchase offer 704, product information pane 706, accept button 708, browse button 710, and terms button 712. Depending on the implementation/configuration, GUI 700 may include additional, fewer, different, or a different arrangement of components than those illustrated in FIG. 7 or described herein. For example, GUI 700 may include/show multiple conditional offers.

Region bar 702 may include similar components as region bar 602 and may operate similarly. Conditional purchase offer 704 may include similar components as conditional sell offer 606 and may operate similarly. However, in contrast to conditional sell offer 606 that applies to individual an item (e.g., a copy of a software application, a pen, a lamp, etc.) that my be sold by conditional selling logic 402, in this particular embodiment, conditional purchase offer 704 applies to a software application whose copies are to be resold by conditional selling logic 402. For example, assume that a software vendor accepts conditional purchase offer 704 for a particular software application. The software vendor may be paid or given credit after conditional selling logic 402 sells copies of the software applications, based on terms that are specified in conditional purchase offer 704.

As shown, conditional purchase offer 704 may include a product description field 716-1, premium price field 716-2, original price field 716-3, premium percentage field 716-4, amount gained field 716-5, time left field 716-6, and number of sales requests field 716-7. Depending on the implementation, conditional purchase offer 704 may include additional, fewer, different, or a different arrangement of fields than those illustrated in FIG. 7.

Description field 716-1 may include a description of one of product s that conditional purchasing logic 404 is offering to purchase. Premium price field 716-2 may indicate the credit which a vendor may receive per a copy of the vendor's software application that is sold by conditional selling logic 402.

Original price field 716-3 may indicate a credit that a vendor would have received for each copy of the vendor's application sold to a buyer (e.g., licensor), if the vendor entered into a resell agreement with conditional purchasing logic 404 without the condition that a minimum number of vendors participate in conditional purchase offer 704. Premium percentage field 716-4 may include the premium price divided by the original price, expressed as a percentage. For example, assumed that premium price field 716-2 includes $3.00 and original price field 716-3 includes $2.50. Premium percentage field 716-4 would include $3.00/$2.50=1.2=120%,

Amount gained field 716-5 may include a difference between the premium price the original price. Time left field 716-6 may include the amount of time for which conditional purchase offer 704 has been open and the total amount of time for which conditional purchase offer 704 is to remain open. For example, in FIG. 7, time left field 716-6 shows 48/90 days, which indicates that conditional purchase offer 704 has been open for 48 days, and is to remain open for the total of 90 days.

Number of purchase requests field 716-7 may include a number of participants that indicated that they will provide one or more of a set of applications and a number of required participants for conditional purchase offer 704, if accepted, to take effect. For example, assume that number of participants field 716-7 includes “13/20” and time left field 716-6 includes “48/90 days.” In such a case, 7 more participants need to accept conditional purchase offer 704 within 42 remaining days. Assume that 7 more participants accept conditional purchase offer 704 within 42 days. In such a case, when a copy of the vendor's software application is sold by conditional selling logic 402, the vendor may receive a credit for the copy at the price specified in premium price field 716-2.

In the above, conditional purchase offer 704 is described in terms of an offer to resell software application (e.g., license the software application to end users). In some implementations, conditional purchase offer 704 may include an offer to buy a good or a service from a vendor, under the condition that participating vendors will sell all of a specified set of products at specified prices. In such a case, a vendor may be paid or credited when all of the vendors agree to sell (i.e., when the condition is met), not when their products are resold.

Product information pane 706 may include fields via which a vendor may provide information pertaining to vendor's software application. Product information pane 706 may include, for example, a field to enter a URL for the vendor's site, a field to provide a directory path for an executable corresponding to the software application, a directory path for an avatar or a thumbnail that may be used for advertising/representing the vendor's application, a directory path to an advertisement document(s), etc.

Accept button 708, when activated, may cause vendor device 104 to send a message to server device 106, indicating that the vendor accepts terms of conditional purchase offer 704. In addition, when activated, accept button 708 may cause vendor device 104 to upload, for example, an executable, avatar, or documents (whose directory paths in vendor device 104 is provided via product information pane 706) to server device 106.

Browse button 710, when activated, may cause vendor device 104 to allow a vendor to browse and select different paths for an executable, avatar, documents, etc. Terms button 712, when activated, may provide a detailed description of terms and conditions of conditional purchase offer 704.

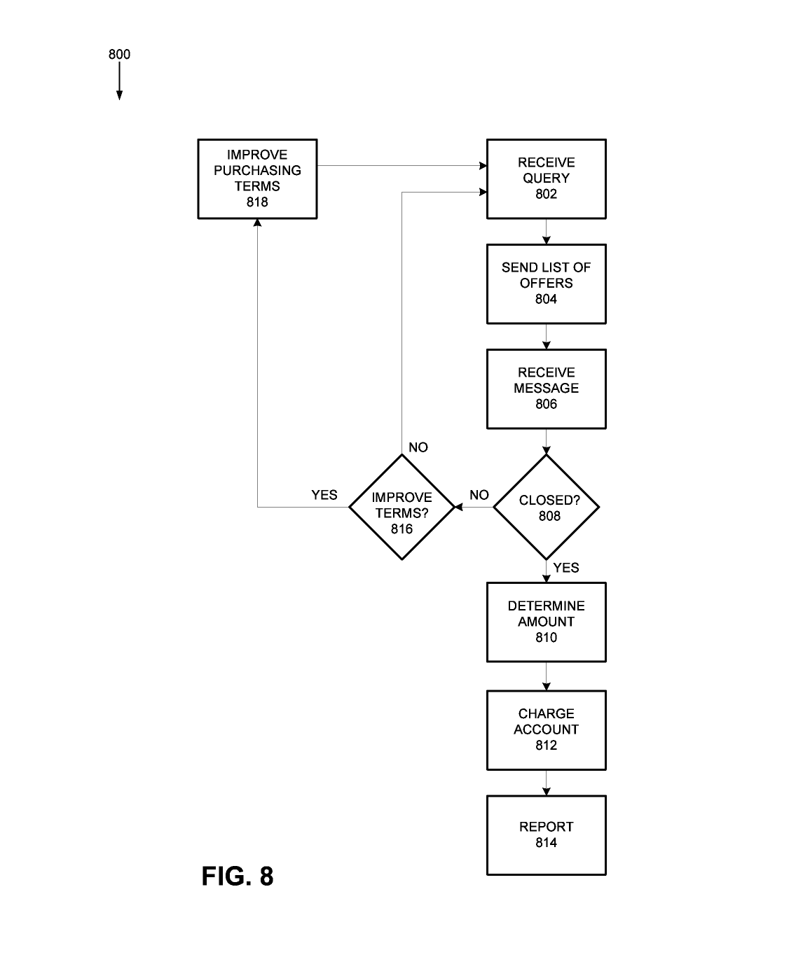

FIG. 8 is a flow diagram of an exemplary process 800 that is associated with conditional sales. Process 800 may be performed by server device 106 and its components (e.g., conditional selling logic 402).

As shown, process 800 may include server device 106 receiving a query or a message from purchaser device 102 requesting server device 106 to provide a list of open sell offers (block 802). The query/message may provide information for server device 106 to narrow down its search space or filter its list. The information may designate, for example, a geographical area, the age or time for which the offer has been outstanding, the original price, the discount price, etc.

In response to the query or the message, server device 106 may send a list of sell offers to purchaser device 102 (block 804). Based on the received list, purchaser device 102 may display the list of offers to a user (e.g., GUI 600).

Server device 106 may receive a message, from purchaser device 102, indicating that the user accepts an offer in the list (block 806). More specifically, the user may agree to purchase a product/service if a threshold number of users also agree to accept the offer, within a specified time. Server device 106 may record information for identifying the user/participant and for contacting the user when the offer becomes closed.

Server device 106 may determine whether the offer is closed (block 808). In one implementation, server device 106 may determine that the offer is closed when the specified time for the offer expires. In another implementation, server device 106 may determine that the offer is closed when the threshold number of users accept the offer.

If server device 106 determines that the offer is closed (block 808: yes), server device 106 may determine the amount to charge individual users that are to purchase the product (block 810). For example, assume that an offer to sell an application is to remain open for 2 days; that if an N number of users reaches a first threshold N1 within the 2 days, the N1 users may purchase individual goods at $2.00 per item; and that if N reaches N2, the N2 users may purchase copies of the application at $1.00 per copy. In such a case, server device 106 may determine whether N<N1, N1≦N<N2, or N2≧N to determine the amount that each of the participating users is to be charged.

Server device 106 may complete selling a product to the participant by charging the participant's account or invoicing the participant (block 812). For example, in one implementation, server device 106 may bill or notify the participant. The participant may pay for the purchase online, by a check, credit card, etc. In another example, in a different implementation, if the participant already has a service account with an entity (e.g., an operator, owner, etc.) that is associated with server device 106, server device 106 may charge the amount to the account, provided that server device 106 has the authority (e.g., the participant has agreed). The participant may prefer to have the amount charged to the account, rather than paying online, for security reasons.

If the product has been obtained from a vendor that have accepted a conditional purchase offer from conditional purchasing logic 404, and any payment to the vendor is contingent upon sales of the product, server device 106 may also pay the vendor (e.g., via account, check, etc.). The paid amount may depend on, for example, terms of the conditional purchase offer.

Once server device 106 has completed the participant's purchase of the product, server device 106 may send a report or a receipt to the participant, via an email, airmail, etc. (block 814).

Returning to block 808, if server device 106 determines that the offer is not closed (block 808: no), server device 106 may determine whether the terms of the offer may be improved (block 816). For example, assume that an offer to sell (e.g., license) an application to the purchaser (e.g., licensor) is to remain open for 2 days; that if N number of participant reaches a first threshold N1 within the 2 days, the N1 participants may license individual copies of the application at $2.00 per copy; and that if N reaches N2, server device 106 may improve the offer by indicating to the participants that if N reaches a second threshold N2 within the 2 days, the N2 users may license individual copies at $1.00 per copy. In such a case, server device 106 may determine whether to improve the offer by determining whether N has reached N1.

If server device 106 determines that the terms are not to be improved (block 816: no), server device 106 may proceed to block 802, to process additional queries or messages about conditional offers. Otherwise, server device 106 may improve the terms of the conditional purchasing offer (e.g., sell the good to the participant/user at a lower price if N reaches N2) (block 818). In improving the terms, server device 106 may also notify the participants that already agreed to the original terms. Thereafter, server device 106 may return to block 802.

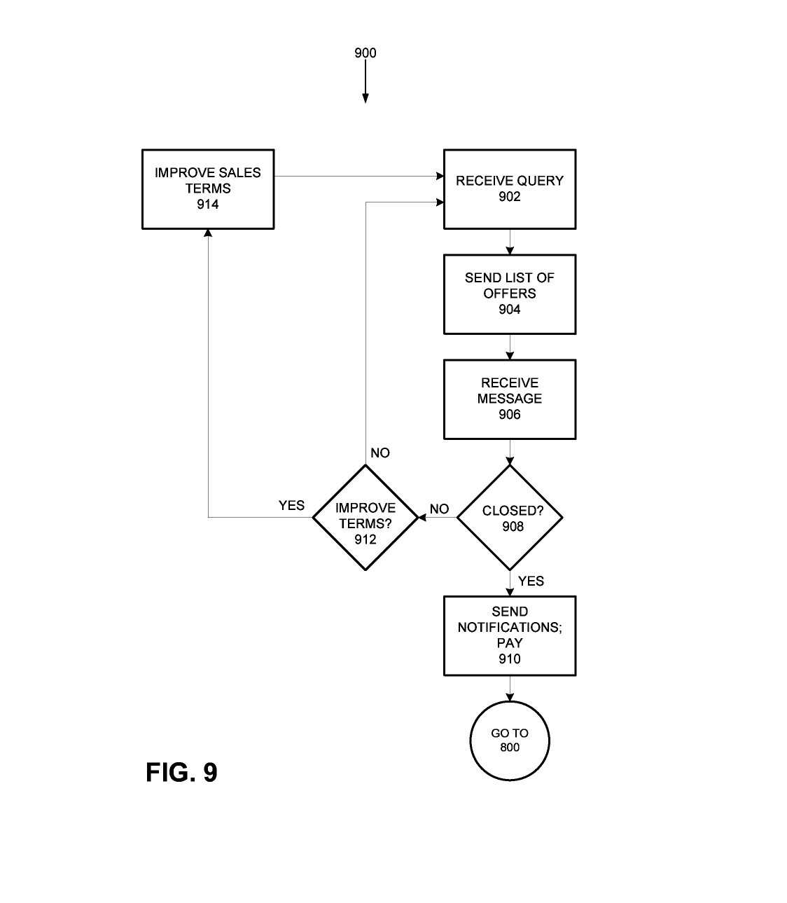

FIG. 9 is a flow diagram of an exemplary process 900 that is associated with conditional purchases. Process 900 may be performed by server device 106 and its components (e.g., conditional purchasing logic 404).

As shown, process 900 may include server device 106 receiving a query or a message from vendor device 104 requesting server device 106 to provide a list of open purchase offers (block 902). In response to the query or the message, server device 106 may send a list of conditional purchase offer(y)to vendor device 104 (block 904).

Server device 106 may receive a message, from vendor device 104, indicating that a user accepts an offer in the list (block 906). In one implementation, the user may agree to conditionally sell a product/service if a threshold number of users also agree to accept the offer, within a time specified for the offer. In another implementation, the user may agree to conditionally sell a product/service if participants contacting the device request to sell all of products/services designated by/in server device 106. Server device 106 may record information for identifying the user/participant and for contacting the user/participant.

Server device 106 may determine whether the offer is closed (block 908). In one implementation, server device 106 may determine that the offer is closed when the specified time for the offer expires. In another implementation, server device 106 may determine that the offer is closed (e.g., server device 106 no longer accepts participant requests to purchase the product) when the threshold number of users accept the offer. In yet another implementation, server device 106 may determine that the offer is closed when all of the specified products/services are offered to be sold by the participants.

If server device 106 determines that the offer is closed (block 908: yes), server device 106 may notify the participants that the offer is closed (block 910). In some situations, participants may also be paid for the products (block 910). If the vendor's product is to be resold and the vendor is to be paid based on the re-sales, server device 106 may proceed to process 800, to make conditional sell offers pertaining to the product. Alternatively, server device 106 may sell the product online, without conditions based on number of purchasers.

Depending on the implementation, server device 106 may pay the participant in different ways. For example, server device 106 may cause a check to be sent to the participant. In a different implementation, if the participant already has a service account with an entity (e.g., an operator) that is associated with server device 106, server device 106 may credit the account, provided that server device 106 has the authority to do so. Once server device 106 completes the purchase, server device 106 may send a report to the participant, via an email, airmail, etc.

Returning to block 908, if server device 106 determines that the offer is not closed (block 908: no), server device 106 may determine whether the terms of the offer may be improved (block 912). For example, assume that an offer to buy applications from vendors is to remain open for 2 days; that if the M number of vendors reaches a first threshold M1 within the 2 days, the M1 vendors may sell individual applications at $2.00 rate; and that if M reaches M2, server device 106 may improve the offer by indicating to the participating vendors that if M reaches a second threshold M2 within the 2 days, the M2 users may sell individual applications at $2.50 rate. In such a case, server device 106 may determine whether to improve the offer by determining whether M has reached M1.

If server device 106 determines that the terms are not to be improved (block 912: no), server device 106 may proceed to block 902, to process additional queries or messages about conditional offers. Otherwise, server device 106 may improve the purchasing terms of the conditional offer (e.g., purchase the good at a higher price if M reaches M2) (block 914). In improving the terms, server device 106 may also notify the participating vendors. Thereafter, server device 106 may return to block 902.

As described above, system 100 may sell a product to a buyer at a specified discount price under the condition that a given number of buyers agree to purchase the product within a prescribed time. If not enough buyers participate in the conditional purchases, system 100 does not sell the product to the buyers at the discount price. Similarly, the system may conditionally purchase a product from a vendor to sell at a premium price, under the condition that a given number of vendors agree to sell specified products within a prescribed time. If not enough vendors participate in the conditional sales, system 100 does not buy the products from the participants at the premium price.

In this specification, various preferred embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

White a series of blocks have been described with regard to the processes 800 and 900 illustrated in FIGS. 8 and 9, the order of the blocks in processes 800 and 900 may be modified in other implementations. In addition, non-dependent blocks may represent blocks that can be performed in parallel.

It will be apparent that aspects described herein may be implemented in many different forms of software, firmware, and hardware in the implementations illustrated in the figures. The actual software code or specialized control hardware used to implement aspects does not limit the invention. Thus, the operation and behavior of the aspects were described without reference to the specific software code—it being understood that software and control hardware can be designed to implement the aspects based on the description herein.

Further, certain portions of the implementations have been described as “logic” that performs one or more functions. This logic may include hardware, such as a processor, a microprocessor, an application specific integrated circuit, or a field programmable gate array, software, or a combination of hardware and software.

No element, block, or instruction used in the present application should be construed as critical or essential to the implementations described herein unless explicitly described as such. Also, as used herein, the article “a” is intended to include one or more items. Further, the phrase “based on” is intended to mean “based, at least in part, on” unless explicitly stated otherwise.

What is claimed is:

1. A device comprising:
a communication interface for communicating with a purchaser device;
one or more processors to:
receive a message from the purchaser device indicating that a participant will purchase a product at a first discount price on a condition that a total number of participants contacting the device to purchase the product at the first discount price is greater than or equal to a first threshold number;
determine whether the total number of participants that have contacted the device to purchase the product at the first discount price is greater than or equal to the first threshold number;
complete a sale of the product to the participant at the first discount price when the one or more processors determine that the total number of the participants that have contacted the device to purchase the product is greater than or equal to the first threshold number; and
initiate billing or invoicing the participant when the sale is completed.

2. The device of claim 1, wherein when the one or more processors initiate billing or invoicing the participant, the one or more processors are further configured to:
charge the participant's account that is associated with a service provider to the participant.

3. The device of claim 1, wherein the one or more processors are further configured to:
receive a message or a query, from the participant device, requesting the device provide a list of open conditional sell offers; and
obtain the list of open conditional sell offers; and
send the list of open conditional sell offers to the purchaser device.

4. The device of claim 3, wherein the list includes, for at least one of the conditional sell offers, one or more of:
a field indicating the first discount price of the product;
a field indicating an original price of the product; or
a field indicating a description of the product.

5. The device of claim 3, wherein the list includes, for at least one of the conditional sell offers, one or more of:
a field indicating a period of time for which the conditional sell offer is to remain open; or
a field indicating a number of participants that have contacted the device to purchase the product.

6. The device of claim 3, wherein the one or more processors are further configured to:
determine whether a conditional sell offer for the product is still open, and
no longer accept requests to conditionally purchase the product when the one or more processors determine that the conditional sell offer for the product is no longer open.

7. The device of claim 6, wherein, when the one or more processors determine whether the conditional sell offer for the product is still open, the one or more processors are further configured to:
determine whether a time period for which the conditional sell offer is to remain open has elapsed.

8. The device of claim 7, wherein the one or more processors are further configured to:
determine whether to improve the conditional sell offer, by setting a second discount price lower than the first discount price and setting a new condition that the purchase of the product is to be completed when the total number of the participants is greater than or equal to a second threshold number that is greater than the first threshold number.

9. The device of claim 1, wherein the one or more processors are configured to:
initiate a payment to a vendor of the product based on a number of the product sold.

10. The device of claim 1, wherein the product includes one of:
a physical good, a service, or a software application.

11. The device of claim 10, wherein when the one or more processors complete the sale of the product, the one or more processors are configured to:
license a copy of the software application to the participant.

12. A method comprising:
receiving, by a device, over a network, a request from a purchaser device indicating that a participant will purchase a product associated with a first conditional sales offer, at a first discount price, on a condition that a total number of participants requesting to purchase the product at the first discount price reaches a first threshold number;
determining, by the device, whether the first conditional sales offer is still open;
determining, by the device, whether the condition that the total number of participants requesting to purchase the product at the first discount price reaches the first threshold number has been satisfied when the first conditional sales offer is determined to be closed; and
completing a sale of the product to the participant at the first discount price when the condition is satisfied.

13. The method of claim 12, further comprising:
receiving, from the purchaser device, a message requesting description of open conditional sales offers;
obtaining a list of open conditional sales offers, the list identifying at least the first conditional sales offer; and
sending the list to the purchaser device;

14. The method of claim 12, wherein the product includes:
a software product, wherein completing the sale of the product includes licensing the product to the participant.

15. The method of claim 12, further comprising:
receiving a request from a vendor to sell the product on a condition that the vendor is to be paid when the product is sold to purchasers participating in the first conditional purchase offer.

16. The method of claim 15, further comprising:
paying the vendor after receiving a payment for the product from the participant.

17. The method of claim 12, wherein completing the sale includes:
invoicing the participant; or
charging the participant's account at a service provider.

18. The method of claim 12, wherein determining whether the first conditional sales offer is still open includes:
determining whether a predetermined length of time for which the first conditional sales offer is to remain open has elapsed; or
determining whether the total number of participants requesting to purchase the product at the first discount price has reached the first threshold number.

19. A device comprising:
a communication interface to:
communicating with a vendor device, and
conduct sales of goods over a network; and
one or more processors to:
receive a message from the vendor device indicating that a participant will sell one of designated products at a first premium price on a condition that all of the designated products will be sold by participants to an entity associated with the device at corresponding, specified prices;
determine whether all of the designated products will be sold by the participants requesting the device to sell products;
complete a purchase of the product from the participant when the one or more processors determine that all of the designated products will be s Ad by the participants requesting to sell products; and
sell the designated products over the network.

20. The device of claim 19, wherein the designated products comprise software applications.
